(19) United States
(12) Patent Application Publication
(10) Pub. No.: US 2026/0348302 A1
(43) Pub. Date: Nov. 5, 2026

(54) A STEAM TURBINE ROTOR FLYWHEEL SYSTEM FOR GRID FREQUENCY STABILIZATION

(71) Applicant: SIEMENS ENERGY GLOBAL GMBH & CO. KG, Munchen (DE)

(72) Inventors: Andrew Crosby, London (GB); David Henery, Newcastle upon Tyne, Heaton (GB); John Envy, Gateshead, Tyne and Wear (GB)

(21) Appl. No.: 19/473,806

(22) PCT Filed: Apr. 10, 2024
(86) PCT No.: PCT/US2024/023778

§ 371 Date: Oct. 9, 2025

(30) Foreign Application Priority Data
May 4, 2023 (GB) 2306615.2

(51) Int. Cl. F01D 25/24; F01D 15/10; F01D 25/12; F03G 3/08; H02K 5/20; H02K 7/02; H02K 7/18; H02K 9/193

(52) U.S. Cl. CPC F01D 25/24; F01D 15/10; F01D 25/12; F03G 3/08; H02K 5/203; H02K 7/02; H02K 7/1823; H02K 9/193

(57) ABSTRACT

A method of providing a flywheel system for grid frequency stabilization is provided. The method may include removing a portion of an outer casing of a steam turbine that includes a rotor therein. The method may include replacing the rotor with a flywheel or converting the rotor into a flywheel by removing at least portions of its turbine blades to decrease the maximum outer diameter of the rotor. The method may also include installing a cooling casing around the flywheel, which includes at least one internal cavity therein to enable fluid flowing therethrough to move heat away from the flywheel. The method may also include installing a seal adjacent each of the opposed cooling casing ends and adjacent the flywheel, which seals and the cooling casing are operable to seal at least a partial vacuum around the flywheel inside the cooling casing relative to atmospheric pressure external to the flywheel system.

### BACKGROUND

Generators, and in particular three-phase synchronous generators are often used to generate grid-suitable electricity using a prime mover such as a gas turbine, a steam turbine, a hydro turbine, and the like. Such generators typically include a stator that remains stationary during operation and a rotor that rotates with respect to the stator. The rotor often includes two or more poles that when rotated interact with the stator to generate the desired current at the desired frequency and voltage.

It should be appreciated that the rotors of such generators and the turbine(s) connected thereto, provide a considerable amount of inertia when rotating, which helps stabilize system frequency on the electrical grid to which they are connected. However, an increasing amount of electrical power on grids is provided from renewable clean energy sources (such as wind and solar), which do not provide beneficial inertia to the grid. Also, this increase in renewables has resulted in a decrease in usage of conventional turbine-based power plants which previously provided a sufficient source of inertia and frequency stabilization to the grid. As a result, frequency fluctuations on the grid are becoming more severe and leading to the disconnection of consumers. Thus, grid stabilization technology may benefit from improvements to compensate for reductions in inertia previously provided by the operation of turbine driven generators.

### BRIEF SUMMARY

Variously disclosed embodiments may include a method of providing a flywheel system for grid frequency stabilization. In one aspect the method may include removing a portion of an outer casing of a steam turbine that includes a rotor therein, which rotor includes turbine blades. The method may include replacing the rotor with a flywheel or converting the rotor into a flywheel by removing at least portions of the turbine blades to decrease the maximum outer diameter of the rotor. The method may also include installing a cooling casing around the flywheel, where the cooling casing may include at least one internal cavity therein to enable fluid flowing therethrough to move heat away from the flywheel, wherein the cooling casing includes opposed cooling casing ends at which respective portions of the flywheel extend therethrough. Further the method may include installing a seal adjacent each of the opposed cooling casing ends and adjacent the flywheel, which seals and the cooling casing are operable to seal at least a partial vacuum around the flywheel inside the cooling casing relative to atmospheric pressure external to the flywheel system.

In one or more aspects the maximum outer diameter of the flywheel, including any remaining portions of turbine blades, may be no more than 90% of the original maximum outer diameter of the rotor, including radial lengths of the tallest turbine blades mounted thereto.

In one or more aspects, the flywheel includes at least one turbine blade with portions thereof removed to shorten the maximum outer diameter of the flywheel relative to the original rotor.

In one or more aspects, removing the portions of the turbine blades includes cutting off at least portions of some of the turbine blades to form shortened turbine blades; and the method may further comprise mounting the shortened turbine blades into slots and/or grooves of the rotor.

In one or more aspects, removing the portions of the turbine blades includes cutting off at least portions of some of the turbine blades to form shortened turbine blades, while these turbine blades remain mounted to the rotor:

In one or more aspects, the method further comprises connecting an air evacuation pump in fluid communication with the flywheel inside the cooling casing, which air evacuation pump is operable to produce the at least partial vacuum.

In one or more aspects, the method further comprises operating the air evacuation pump to produce the partial vacuum around the flywheel with a pressure that is less than 800 mbara.

In one or more aspects, the method further comprises connecting a cooling fluid pump in fluid communication with the cooling casing, which cooling fluid pump is operable to circulate a liquid through the at least one internal cavity so as to move heat away from the flywheel.

In one or more aspects, the method further comprises operating the cooling fluid pump to circulate a liquid through the at least one internal cavity of the cooling casing.

In one or more aspects, the outer casing includes an upper casing and a lower casing, wherein the portion of the outer casing that is removed is the upper casing, wherein the lower casing remains in place after removing the upper casing. The method may further comprise installing a support cradle between the lower casing and the cooling casing to support the cooling casing.

In one or more aspects, the method further comprises installing the upper casing back onto the lower casing, such that the outer casing extends circumferentially around the flywheel and the cooling casing.

In one or more aspects, the flywheel is coupled directly or indirectly to a rotor of a generator mounted in a power plant connected to an electrical grid. The method may further comprise providing rotational inertia to the generator via rotation of the flywheel.

In one or more aspects, the method may be carried out on at least one low pressure (LP) steam turbine and at least one intermediate (IP) steam turbine, wherein providing rotational inertia to the generator is provided by both the flywheel formed out of the rotor in the LP steam turbine and the flywheel formed out of the rotor in the IP steam turbine.

In one or more aspects, the rotor of the LP steam turbine has a mass, including its turbine blades and maximum outer diameter (e.g., at its last stage row of turbine blades), which are at least 50% larger than the corresponding mass including its turbine blades and maximum outer diameter (e.g., at its last stage row of turbine blades) of the rotor of the IP steam turbine, wherein the mass of the flywheel formed out of the rotor in the LP steam turbine is at least 50% larger than the mass of the flywheel formed out of the rotor in the IP steam turbine.

A further aspect may include an inertia train system for grid frequency stabilization formed via one or more aspects of the method.

Another aspect may include a flywheel system for grid frequency stabilization formed via one or more of aspects of the method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

To easily identify the discussion of any particular element or act, the most significant digit or digits in a reference number refer to the figure number in which that element is first introduced.

FIG. 1 illustrates a cross-sectional view of a prior art intermediate pressure (IP) steam turbine.

FIG. 2 illustrates a cross-sectional view of a prior art low pressure (LP) steam turbine.

FIG. 3 illustrates a cross-sectional view of the former IP steam turbine of FIG. 1 after being converted into an IP rotor flywheel system.

FIG. 4 illustrates a top plan view of a former steam turbine train having three LP rotors and one IP rotor after being converted into an inertia train system including three LP rotor flywheel systems and one IP rotor flywheel system, with upper casings removed.

FIG. 5 illustrates a methodology 500 in accordance with one embodiment.

### DETAILED DESCRIPTION

Before any embodiments of the invention are explained in detail, it is to be understood that the invention is not limited in its application to the details of construction and the arrangement of components set forth in this description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods of providing grid frequency stabilization inertia will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean that an element is relatively near to but not in contact with a further element or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard is available, a variation of twenty percent would fall within the meaning of these terms unless otherwise stated.

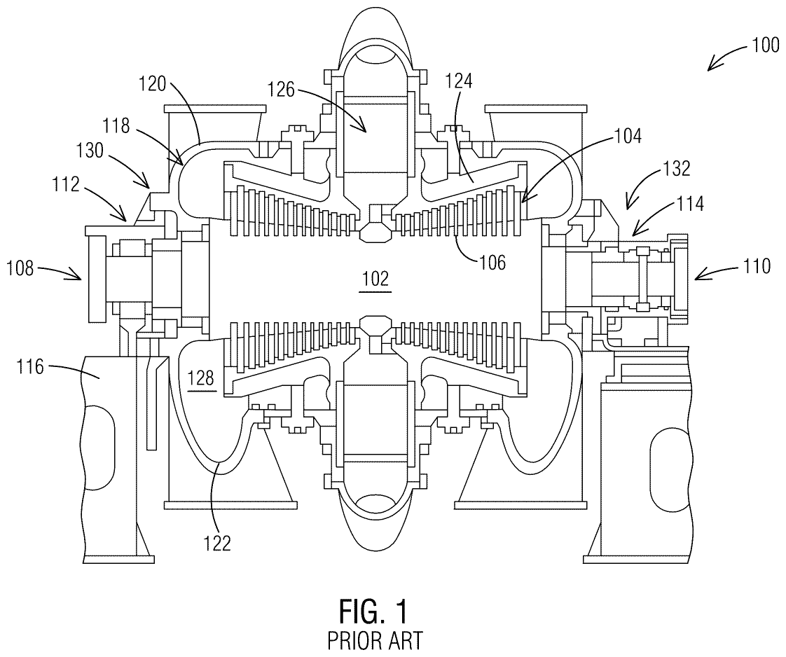

Example embodiments described herein are directed to adapting at least one pre-existing steam turbine (which powers an electrical generator) to become a steam turbine rotor flywheel system, which provides inertia for grid frequency stabilization. FIG. 1 illustrates a cross-sectional view of an example prior art steam turbine 100 that may be adapted according to example embodiments described herein to become a steam turbine rotor flywheel system. Such a steam turbine (also referred to herein as a turbine) comprises a rotor 102 including several rows or sets of turbine blades 104 that extend radially outwardly from a central longitudinal (i.e., rotational axis) of the rotor. Each of the turbine blades may include a root 106 which extends into the rotor body in locking engagement therewith (e.g., in various slots and/or groves in the rotor body).

The rotor includes opposed ends 108, 110, and each end of the rotor may extend through a respective bearing 112, 114, to enable the rotor to rotate about its longitudinal axis. Also, each bearing may be supported by a pedestal 116 or other support structure. In example embodiments, the steam turbine includes an outer casing 118 that extends circumferentially around the rotor and includes opposed ends 130, 132 respectively adjacent the opposed ends 108, 110 of the rotor. The outer casing 118 is typically comprised of multiple parts, such as an upper casing 120 that is bolted to a lower casing 122. The casing may include a plurality of inlets 126 and outlets 128. Steam is initially fed through inlets 126 into in the casing, which is directed to urge the turbine blades 104 to impart a tangential force, which causes the rotor to rotate. The expanded steam exhausts though the several outlets 128 out of the casing after passing the last (tallest) row of blades. In this example, the turbine may also include or be connected to additional structure within the casing that may be referred to as an inner casing 124 that directs the steam to flow from shorter first row blades along the rotor to tallest last row blades.

In this example, the steam turbine corresponds to an intermediate pressure (IP) steam turbine 100. However, as will be described in more detail below, the steam turbine that is adapted may correspond to a low pressure (LP) steam turbine, a high pressure (HP) steam turbine and/or any other type of steam turbine and/or combinations thereof. In general, a large power plant (such as a nuclear plant) may include an electrical generator that is driven by a turbine train typically comprised of at least one HP turbine, at least one IP turbine, and at least one LP turbine, each having their respective rotors coupled together along a common rotational axis.

It should be appreciated that each type of steam turbine respectively from HP turbine to IP turbine to LP turbine, is configured to operate at sequentially relatively lower pressure and temperature levels of steam, and higher volumes of steam, and thus have sequentially relatively larger sizes for their rotors and blade sets. Initial high-pressure steam may undergo expansion in the relatively smaller HP turbine. The relatively cooler and relatively lower intermediate pressure of the exhaust steam from the HP turbine may then be fed into the relatively larger IP turbine where it may undergo further expansion. The relatively cooler and relatively lower low pressure of the exhaust steam from the IP turbine may then be fed into one or more larger LP turbines where it undergoes yet further expansion. The continuous expansion of steam from HP to IP to LP is operative to drive their respective rotors and cause the generator to spin and produce electrical power. Although models and implementations for such steam turbines may have different relative sizes and operate at different ranges of pressure levels, for purposes of distinguishing an LP turbine from an IP turbine herein, an LP turbine is defined as having an LP rotor with a mass (including its blades) and maximum outer diameter (e.g., at its last stage row of blades) that are at least 50% larger than the corresponding mass (including its blades) and maximum outer diameter (e.g., at its last stage row of blades) of the rotor of an IP turbine.

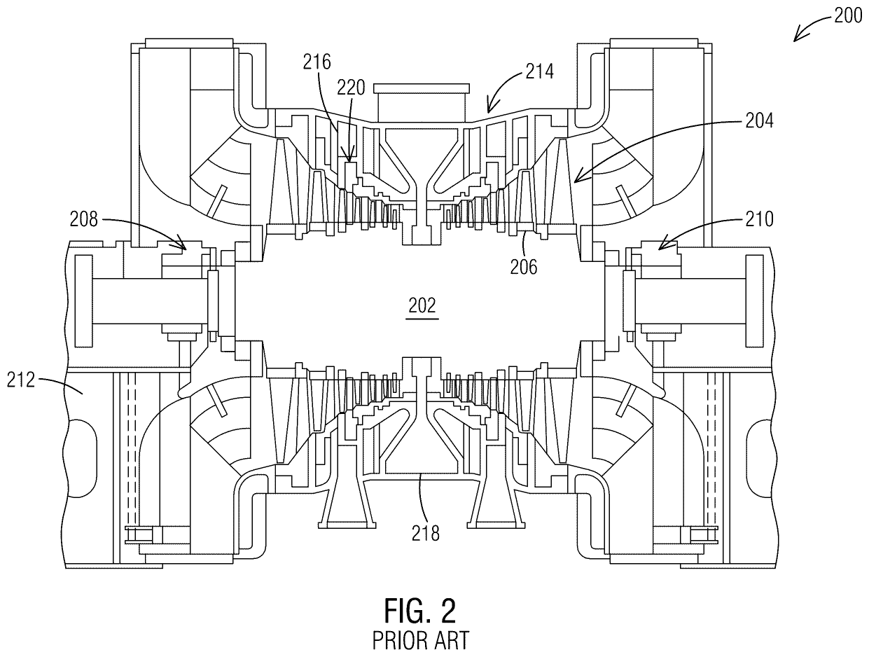

FIG. 2 illustrates a cross-sectional view of an example prior art LP steam turbine 200. Similar to an IP turbine, such an LP turbine may include a rotor 202 in rotational engagement with bearings 208, 210 supported on pedestals or other support structures. Such a rotor may similarly include turbine blades 204 having roots 106 in locking engagement with the rotor body. The outer casing 214 may also be comprised of multiple parts including an upper casing 216 bolted to a lower casing 218. In addition, the inner structure of the casing of the LP turbine may include or be connected to internal features adjacent the blades such stationary blade carriers and blade rings 220. However, it should be appreciated that such an LP turbine will have a larger rotor and larger blades compared to an IP turbine connected to the same generator. In addition, inlets, outlets, and other internal and external structures may have a different shape or configuration compared to the corresponding features of an IP turbine in order to accommodate relatively lower pressure and higher volumes of steam.

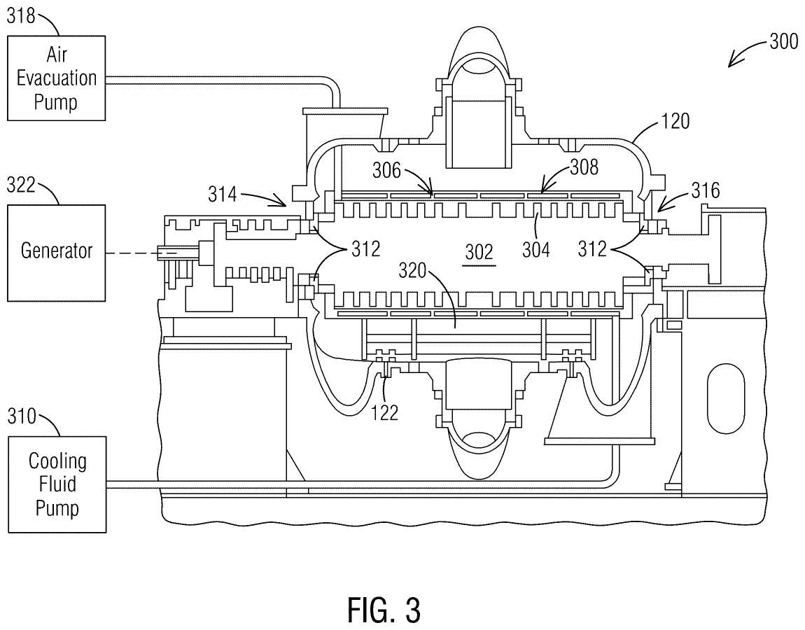

To provide inertia for grid frequency stabilization, the example steam turbines described with respect to FIGS. 1 and 2, may be adapted to become steam turbine rotor flywheel systems (also referred to herein as flywheel systems), that provide additional inertia to the rotor of a generator (even though such systems are no longer powered by steam). FIG. 3 illustrates a back cross-sectional view of the former IP steam turbine 100 of FIG. 1 after being converted into an IP rotor flywheel system 300. This flywheel system 300 may continue to include most of the same rotor 102 as was present in the IP turbine 100 (shown in FIG. 1). However, the rotor is modified to remove or modify all or at least portions of the original turbine blades of the rotor. This converted form of the rotor is referred to herein and in the claims as a flywheel 302.

In an example embodiment, removing the portions of the turbine blades connected to the rotor may be carried out by cropping all or some of the plurality of blades down to the hub to remove the blade profile partially or completely, with their roots remaining in the slots or grooves of the rotor. Such shortened turbine blades 304 may be cut down to a shortened size while attached to the rotor and/or may cut down after being removed from the rotor, and then be remounted to the rotor in a shortened form. However, in alternative embodiments all or some of the original blades (including their roots) maybe be removed and not replaced. In other embodiments, some or all of the original turbine blades may be removed and replaced with other elements that can lockingly engage with the rotor body, including used turbine blades from another steam turbine that have been refurbished into a shape with shorter radial heights.

In an example embodiment, the maximum outer diameter of the flywheel 302, including any remaining turbine blades, may be no more than 90% of the original maximum outer diameter of the rotor, including radial lengths of the tallest blades mounted thereto. This shortening of the maximum outer diameter of the flywheel compared to the original rotor, provides a larger space between the flywheel 302 and the upper and lower casings 120, 122.

In addition to removing and/or shortening at least some of the turbine blades, portions of the internal structures within the outer casing adjacent the original turbine blades (such as the inner casing 124 shown in FIG. 1) may also be removed. The resulting additional space between the flywheel 302 and the upper and lower casings 120, 122 is created to enable the installation of a cooling casing 306 around the flywheel 302. The cooling casing may correspond to a fluid jacket having at least one internal cavity 308 or a plurality of cavities therein to enable fluid flowing therethrough to move heat away from the flywheel 302. The flywheel system 300 may further include at least one cooling fluid pump 310 to circulate a fluid (which may include water and/or another liquid), through the internal cavities 308 of the cooling casing 306. It should be appreciated that the cooling fluid pump 310 is shown schematically in FIG. 3, and that an example implementation may include additional piping, fluid sources, fluid tanks, heat exchangers, and/or other features to circulate a fluid capable of removing heat (generated by the rotating flywheel) away from the cooling casing 306 and flywheel 302.

In example embodiments, the cooling casing 306 may in addition (or alternatively) serve as a vacuum chamber around portions of the flywheel 302. If the flywheel rotated in air at atmospheric pressure, large mechanical losses would be induced, apparent as windage heating of the surrounding air and noise. This would require significant power input to the flywheel from the electrical input to the generator. The cooling casing enables a vacuum to be created. Operating the flywheel in a vacuum reduces windage heating of the air around the flywheel. This reduces the power required to operate the unit, and the windage heat generated.

To seal a partial vacuum inside the cooling casing relative to atmospheric pressure external to the flywheel system, example embodiments may include the installation of seals 312. Such seals may be positioned adjacent opposed cooling casing ends 314, 316 at which respective portions of the flywheel 302 extends therethrough. The seals may have the form of a seal ring or other structure that extends around portions of the flywheel and that function to prevent or at least reduce the flow of air between the flywheel and the cooling case.

The system 300 may also include at least one air evacuation pump 318 in fluid communication (e.g., via pipes or other conduits) with the flywheel 302 inside the cooling casing 306. The air evacuation pump may be configured to pump air molecules out of the cavity formed by the cooling case around the flywheel in order to produce at least a partial vacuum therein. In an example embodiment, the air evacuation pump, seals, and cooling casing may be operably configured to achieve a partial vacuum around the flywheel that is less than 800 mbara.

To support the cooling casing around the flywheel, a support cradle 320 may be installed between the lower casing 122 and cooling casing. Such a support cradle may be bolted and/or welded to both the lower casing and the cooling casing to maintain the cooling casing in a fixed position around portions of the flywheel and to prevent interior walls of the cooling case from contacting the flywheel. Alternatively integral support features corresponding to the cradle may be designed into the cooling casing to support the cooling casing from the existing station infrastructure such as mounting to the lower casing.

It should be appreciated that in order to modify a steam turbine to become the described flywheel system 300, the upper casing 120 is unbolted and removed from the lower casing 122. During the described adaption of the rotor into a flywheel, the lower case may remain in its original position, and the rotor itself may remain engaged with its existing bearings. Once the flywheel 302 is formed, and the cooling casing with seals are installed, the upper casing 120 may be reinstalled and bolted to the lower casing 122, such that the outer casing circumferentially extends around at least portions of both the flywheel and the cooling casing. However, in alterative embodiments the flywheel system may operate without the upper casing being reinstalled.

It should also be appreciated that the flywheel 302 in operation may be connected directly to a rotor of the generator 322. However, in other example embodiments, the flywheel 302 may be indirectly connected to the generator 322 though the flywheels of other flywheel systems. Such other flywheel systems may similarly be formed by adapting other existing steam turbines that are coupled together as a rotor train (e.g., including at least some of the IP, LP, and/or HP turbines connected to the generator 322). Thus, example embodiments may form an inertia train system comprised of several flywheel systems all connected in series to the rotor of the generator.

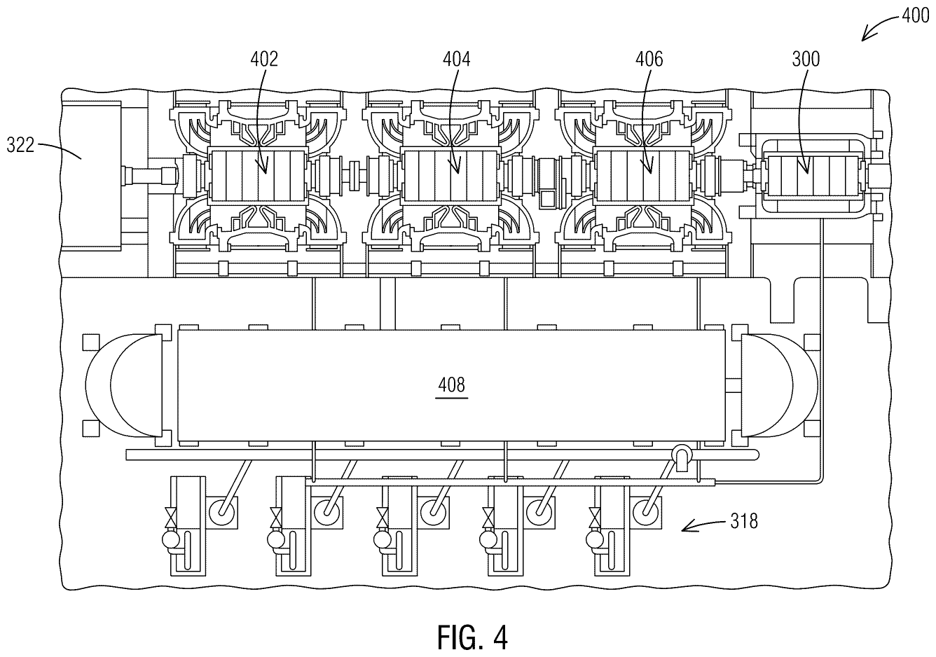

FIG. 4 illustrates a top plan view of a former steam turbine rotor train having three LP rotors and one IP rotor after being converted into an inertia train system 400 including respectively three LP rotor flywheel systems 402, 404, 406 and one IP rotor flywheel system 300, with upper casings removed. The LP rotor flywheel systems depicted in this example inertia train system, correspond to an example conversion of the prior art LP turbine depicted in FIG. 2. In general, the features and processes described with respect to forming the IP rotor flywheel system 300 of FIG. 3 are applicable to forming LP rotor flywheel systems 402, 404, 406. However, it should be appreciated that the adaption process and final configurations of the flywheels, seals, cooling casings, support cradles may differ based on structural variations between an IP turbine and an LP turbine. For example, the LP turbines may include internal casing structures, such as the described stationary blade carriers and blade rings 220 (depicted in FIG. 2), which may need to be at least partially removed from the upper and lower casings to provide sufficient space for the cooling casing and/or the support cradle. As discussed previously, LP turbines are much larger than IP turbines. Thus, in an example embodiment the mass of the flywheel formed out of the rotor in the LP turbine may be at least 50% larger than the mass of the flywheel formed out of the rotor in the IP turbine.

In example embodiments, some of the preexisting structures and systems associated with the steam turbines may be obsolete after the steam turbines are converted to the described flywheel systems. In particular, a condenser 408 may remain without a purpose, and in example embodiments may remain adjacent the flywheel systems or be removed. Further, it should be appreciated that the described flywheel systems may continue to use any applicable sensors, control systems, lubrications systems, and/or any other pre-existing systems that are useful for the operation of the flywheel system.

Further it should be understood that these described adaptions of an IP and LP turbine are not limited to just these particular types or models of turbines, but are intended to illustrate example processes and structures that may be used for other types of steam turbines connected to generators to form flywheel systems from preexisting hardware and components. It should also be appreciated that variations of the described structure and processes may also be carried out to achieve a similar functioning flywheel system. For example, in an alternative embodiment rather than modifying an existing rotor in an existing steam turbine, the rotor of the existing steam turbine may instead be replaced with a new flywheel having a shape adapted for mounting to the existing bearings of the existing steam turbine with the described cooling casing and existing external casing extending therearound.

Use of the described flywheel system 300 and/or the inertia train system 400 provides several advantages to grids that are employing larger amounts of renewables (such as wind and Solar). For example, in addition to providing mechanical inertia, which resists changes to grid frequency, the described systems may also provide a reserve of stored energy to help maintain the electrical grid during short term grid faults such as short circuits. Further, described systems may provide reactive power for voltage control and stability.

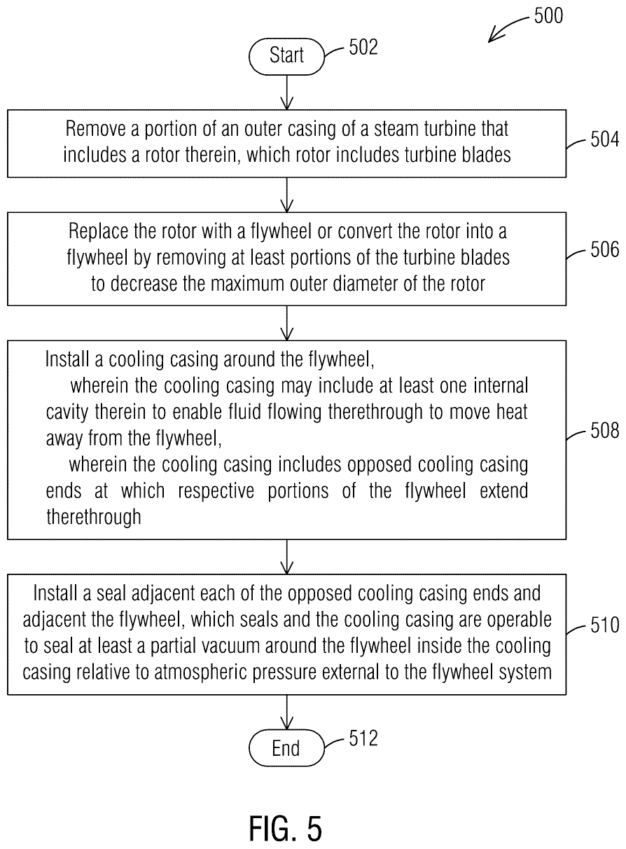

Referring now to FIG. 5, an example methodology 500 is illustrated that provides a flywheel system for grid frequency stabilization. While the methodology is described as being a series of acts that are performed in a sequence, it is to be understood that the methodology may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

The methodology starts at 502 and may include an act 504 of removing a portion of an outer casing of a steam turbine that includes a rotor therein, which rotor includes turbine blades. In act 506, the methodology 500, may include replacing the rotor with a flywheel or converting the rotor into a flywheel by removing at least portions of the turbine blades to decrease the maximum outer diameter of the rotor. In act 508, the methodology 500 may include installing a cooling casing around the flywheel The cooling casing may include at least one internal cavity therein to enable fluid flowing therethrough to move heat away from the flywheel. The cooling casing includes opposed cooling casing ends at which respective portions of the flywheel extend therethrough. In act 510, methodology 500 may include installing a seal adjacent each of the opposed cooling casing ends and adjacent the flywheel, which seals and the cooling casing are operable to seal at least a partial vacuum around the flywheel inside the cooling casing relative to atmospheric pressure external to the flywheel system. At 512 methodology 500 may end.

It should be appreciated that this described methodology may include additional acts and/or alternative acts corresponding to the features described previously with respect to the flywheel system 300 and/or the inertia train system 400.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

1. A method of providing a flywheel system for grid frequency stabilization, comprising:
removing a portion of an outer casing of a steam turbine that includes a rotor therein, which rotor includes turbine blades;
replacing the rotor with a flywheel or converting the rotor into a flywheel by removing at least portions of the turbine blades to decrease the maximum outer diameter of the rotor;
installing a cooling casing around the flywheel, wherein the cooling casing includes at least one internal cavity therein to enable fluid flowing therethrough to move heat away from the flywheel, wherein the cooling casing includes opposed cooling casing ends at which respective portions of the flywheel extend therethrough; and
installing a seal adjacent each of the opposed cooling casing ends and adjacent the flywheel, which seals and the cooling casing are operable to seal at least a partial vacuum around the flywheel inside the cooling casing relative to atmospheric pressure external to the flywheel system.

2. The method of claim 1, wherein the maximum outer diameter of the flywheel, including any remaining portions of turbine blades, is no more than 90% of the original maximum outer diameter of the rotor, including radial lengths of the tallest turbine blades mounted thereto.

3. The method of claim 2, wherein the flywheel includes at least one turbine blade with portions thereof removed to shorten the maximum outer diameter of the flywheel relative to the original rotor.

4. The method of claim 3, wherein removing the portions of the turbine blades includes cutting off at least portions of some of the turbine blades to form shortened turbine blades, wherein further comprising:
mounting the shortened turbine blades into slots and/or grooves of the rotor.

5. The method of claim 3, wherein removing the portions of the turbine blades includes cutting off at least portions of some of the turbine blades to form shortened turbine blades, while these turbine blades remain mounted to the rotor.

6. The method of claim 1, further comprising:
connecting an air evacuation pump in fluid communication with the flywheel inside the cooling casing, which air evacuation pump is operable to produce the at least partial vacuum.

7. The method of claim 6, further comprising operating the air evacuation pump to produce the partial vacuum around the flywheel with a pressure that is less than 800 mbara.

8. The method of claim 6, further comprising:
connecting a cooling fluid pump in fluid communication with the cooling casing, which cooling fluid pump is operable to circulate a liquid through the at least one internal cavity so as to move heat away from the flywheel.

9. The method of claim 8, further comprising operating the cooling fluid pump to circulate a liquid through the at least one internal cavity of the cooling casing.

10. The method of claim 1, wherein the outer casing includes an upper casing and a lower casing, wherein the portion of the outer casing that is removed is the upper casing, wherein the lower casing remains in place after removing the upper casing, wherein the cooling casing includes integral supports that mount to the lower casing and support the cooling case in place.

11. The method of claim 1, wherein the outer casing includes an upper casing and a lower casing, wherein the portion of the outer casing that is removed is the upper casing, wherein the lower casing remains in place after removing the upper casing, further comprising:
installing a support cradle between the lower casing and the cooling casing to support the cooling casing.

12. The method of claim 1, further comprising installing the upper casing back onto the lower casing, such that the outer casing extends circumferentially around the flywheel and the cooling casing.

13. The method of claim 1, wherein the flywheel is coupled directly or indirectly to a rotor of a generator mounted in a power plant connected to an electrical grid, further comprising:
providing rotational inertia to the generator via rotation of the flywheel.

14. The method of claim 13, carried out on at least one low pressure (LP) steam turbine and at least one intermediate (IP) steam turbine, wherein providing rotational inertia to the generator is provided by both the flywheel formed out of the rotor in the LP steam turbine and the flywheel formed out of the rotor in the IP steam turbine.

15. The method of claim 14, wherein the rotor of the LP steam turbine has a mass, including its blades and maximum outer diameter at its last stage row of blades, which are at least 50% larger than the corresponding mass including its turbine blades and maximum outer diameter at its last stage row of turbine blades of the rotor of the IP steam turbine, wherein the mass of the flywheel formed out of the rotor in the LP steam turbine is at least 50% larger than the mass of the flywheel formed out of the rotor in the IP steam turbine.

16. (canceled)
